(19) United States
(12) Patent Application Publication
(10) Pub. No.: US 2009/0100696 A1
(43) Pub. Date: Apr. 23, 2009

(54) Device For Drying A Textile Containing A Filling That Is Likely To Form Clumps

(75) Inventor: Klaus Grunert, Berlin (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/225,075

(22) PCT Filed: Mar. 6, 2007
(86) PCT No.: PCT/EP2007/052070

§ 371 Date: Sep. 10, 2008

(30) Foreign Application Priority Data
Mar. 17, 2006 (DE) 10 2006 012 450.2

(51) Int. Cl. F26B 19/00; D06F 58/04

(52) U.S. Cl. 34/60; 34/109

(57) ABSTRACT

A device for drying a textile containing a filling that is likely to form clumps, especially down, including a rotatable drum for accommodating and agitating the textile in an airflow traveling through the drum. The device includes at least one beater, mounted in the drum and moved by the textile article, for beating the textile article while it is agitated.

The present invention relates to a device for drying a textile article containing a filling that is likely to form clumps, comprising a drum which is rotatable about an axis and accommodates and agitates the textile article in an airflow passing through the drum.

A device of this type is described in EP 1 048 996 B1, EP 1 098 028 B1 and EP 1 108 812 B1. Each of these documents discloses a corresponding device, configured as a washing dryer for use in an ordinary household.

The invention relates in particular to the drying of a textile article such as a duvet, a pillow, a cushion, a jacket, a coat or a sleeping bag which is provided with a filling of down. Down has the property in its dry condition of swelling or puffing up and thereby including a large amount of air between its components. This air, in turn, leads thereto that a textile article of this type is perceived as being both soft and warming due to the insulating effect of the air included in this way. In place of down, an unfelted mass of artificially produced fibers, in particular hollow fibers, can be used.

It is essentially possible to wash such a textile article in a washing machine for a private household and subsequently to dry it in a suitable conventional dryer. However, a filling made from down or similar unfelted fibers tends to form clumps when it is moistened with water. Such clumps are very difficult to break up in a conventional dryer and the water absorbed in them is very difficult to remove. It is known for this purpose to add tennis balls or running shoes made from textiles and rubber in a conventional dryer with the textile article to be dried. During the drying process wherein the textile article is agitated in the dryer, it is beaten by the additionally included objects and the clumps can thereby be broken up and the water absorbed therein removed.

It is an object of the invention to provide a technical embodiment of a washing dryer or of the aforementioned device wherein the drying of a textile article with a filling that is likely to form clumps is made available and comprehensible to a wide circle of users. All the necessary aids should be included in the washing dryer or the device and be capable of activation by an ordinary operator when required.

In order to achieve this aim, a device for drying a textile article with a filling that is likely to form clumps is described, comprising a drum which is rotatable about an axis and accommodates and agitates the textile article in an airflow passing through the drum, wherein at least one beater which is movable with the textile article is mounted in the drum in order to beat the textile article during the agitation.

The invention and developments thereof are disclosed in the present claims.

According to the invention, the aforementioned device is enhanced with at least one component which can be activated and deactivated by an ordinary user when required and which causes the necessary beating of the textile article for satisfactory drying of a textile article containing a filling that is likely to form clumps.

Preferably, the beater is connected to the drum by means of a cord and otherwise freely movable within the drum. Furthermore, the drum preferably has a closable chamber for optional accommodation of the beater, so that the beater can be stored in this chamber when it is not needed. Preferably also, this chamber is situated in an agitator for moving the textile article when the drum rotates, or in a back wall of the drum.

Preferable is also an alternative development of the invention wherein the drum has at least one agitator for moving the textile article during rotation, and wherein the beater is a lever which is movably articulated on an agitator. Preferably also, this lever can optionally be fastened to the agitator.

Preferably, the drum has three or four agitators.

The beater is preferably configured with a length in the range of 150 mm to 200 mm, and in particular as a cylinder with rounded ends.

Preferably, the beater has a diameter in the range of 50 mm to 70 mm.

Preferably also, the beater has a mass in the range of 100 g to 200 g.

The provision of a plurality of beaters in the device is advantageous under certain circumstances, in order to promote the drying of the textile article.

The device is preferably configured as a washing dryer, in particular for use in an ordinary household.

In general, the invention discloses the drying of a textile article with a filling that is likely to form clumps, for a normal household. The means necessary for this purpose is an integral component of the device and, when its use is not needed, can be fixed captively in the device and without impairing any other function of this device. This means is configured in its dimensions and its mass so that a clumped filling is loosened, but no damage is caused to the textile article being treated and to the filling. It should be noted that a conventional running shoe made from textile and rubber is somewhat too heavy for this purpose and entails the risk of damage to the filling. A tennis ball is somewhat too light for the purpose and may therefore also incompletely fulfill the desired purpose. Suitable for the means is an elongated form, in order to increase the likelihood during its use that each clump in the filling is beaten to a sufficient extent.

When this device is used to dry a textile article with a filling that is likely to form clumps, a reduced heating output should be used compared with a conventional drying process, in order to prevent the textile surrounding the filling from drying too rapidly, which could make it brittle and place excessive demands on the filling during the drying.

Exemplary embodiments of the invention are illustrated in the drawings, in which:

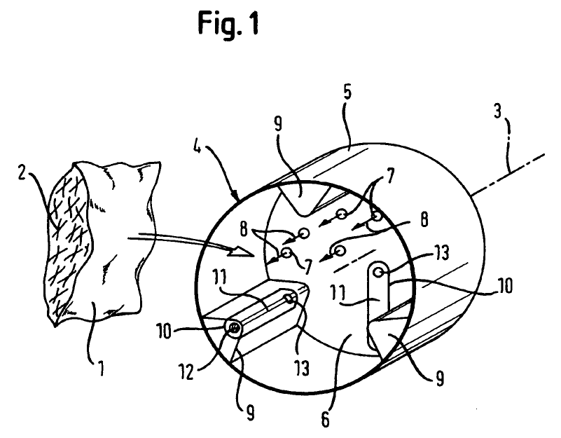

FIG. 1 shows a device for drying a textile article containing a filling that is likely to form clumps;

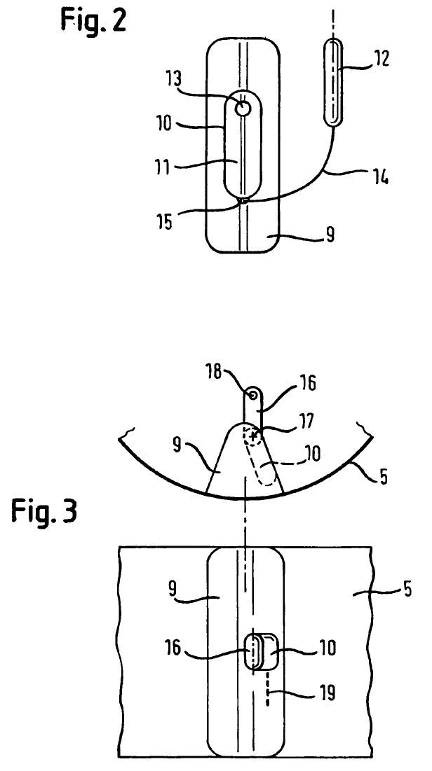

FIG. 2 shows a view of an agitator;

FIG. 3 shows partial views of another device for drying a textile article containing a filling that is likely to form clumps.

Each drawing should be understood as a sketch and contains only the elements of the respective device shown that are of relevance to the following description. The drawings are not to scale.

FIG. 1 shows a sectional view of a device for drying a textile article 1, containing a filling 2 that is likely to form clumps, for example, down. The device comprises a drum 4 which is rotatable about an axis 3 and has a cylindrical casing 5 surrounding the axis 3 and a rear wall 6 oriented approximately perpendicularly to the axis 3. Not shown is a circular front wall of the drum 4 adjoining the casing 5 and facing from there towards the axis 3, as provided in a conventional washing dryer. For the sake of clarity, further components of a washing dryer of this type, to which the device shown belongs, are not shown in the illustration; relevant information is disclosed in the cited prior art documents. Arranged in the rear wall 6 are holes 7 of which, in the present case, only a small number can be seen. An airflow 8 passes through these holes 7, indicated by arrows, into the drum 4 and impinges upon the washing which is situated therein and is agitated by the rotation of the drum 4 about the axis 3 to support the drying. In order to bring about this agitation, three agitators 9 are mounted in the interior of the drum 4 and on its casing 5. Arranged in the agitator 9 shown at bottom left is a chamber 10 which is closed by a cover 11. Arranged in this chamber 10 is a beater 12 which can optionally be taken out. In order to open the cover 11, said cover 11 is provided with a grip hole 13; the cover 11 is locked in place with conventional locking means (not shown for the sake of clarity) in the agitator 9. A further chamber 10 is provided in the rear wall 6; said chamber 10 is also closed by means of a cover 11. In order to dry the textile article 1 with the filling 2 that is likely to form clumps, the beater 12 is taken out of the chamber 10, so that it lies more or less freely movable in the drum 4 and, during rotation thereof, beats the textile article 1 and the partially clumped filling 2 arranged therein.

Also provided in the rear wall 6 of the drum 4 is a chamber 10 for accommodating a beater 12 of similar form and mass.

FIG. 2 shows a view of the agitator 9 with the beater 12 taken out. The beater 12 is elongated and has the form of a cylinder with rounded ends; it has a length in the range of 150 mm to 200 mm and a diameter in the range of 50 mm to 70 mm and a mass in the range of 100 g to 200 g. The beater 12 is captively fastened in the drum 4 with a cord 14. The cord 14 is anchored in the chamber 10 and is fed out of the chamber 10 through a small cut-out 15 in the agitator, adjacent to the cover 11.

FIG. 3 shows another exemplary embodiment of the device wherein the device is illustrated only in part. Mounted on the casing 5 is an agitator 9 and mounted on this agitator 9 is a beater 16 in the form of a movable lever 16 articulated on a joint 16 on the agitator 9 which is only sketched in the drawing. In its function as a beater 16, the lever 16 is freely movable over at least a large angle 3, of almost 180°, in order to beat a textile article 1 containing a filling 2 that is likely to form clumps which is to be dried in the device, and thereby to loosen the filling 2. If the lever 16 is not to be used, it can be pivoted into the chamber 10 in the agitator 9. In order to fix it in this chamber 10, it has a locking hole 18 in which a bar 19 provided in the agitator 9, and only schematically indicated in FIG. 3, engages.

It should be described that a plurality of beaters 12 or 16 can be provided in each embodiment of the device.

The device described here for drying a textile article containing a filling that is likely to form clumps and the washing dryer comprising this device enable drying of textiles filled with down or the like for a wide circle of users. All equipment necessary for drying textiles of this type are included in the device.

### REFERENCE SIGNS

1 Textile article
2 Filling
3 Axis
4 Drum
5 Casing
6 Rear wall
7 Holes
8 Airflow
9 Agitator
10 Chamber
11 Cover
12 Beater
13 Grip hole
14 Cord
15 Cut-out for cord
16 Beater
17 Joint
18 Locking opening
19 Bar

1-14. (canceled)

15. A device for drying a textile article containing a filling that is likely to form clumps including a rotatable a drum for accommodating the textile article and agitating the textile article in an airflow passing through the drum, the device for drying a textile article comprising at least one beater mounted in the drum, the beater being movable with the textile article within the drum for beating the textile article during an agitation process.

16. The device according to claim 15 wherein the beater is connected to the drum using a cord and is otherwise freely movable in the drum.

17. The device according to claim 16 wherein the drum includes a closable chamber for optional accommodation of the beater.

18. The device according to claim 17 wherein the drum includes at least one agitator for moving the textile article when the drum is rotated and the closable chamber is disposed within the agitator.

19. The device according to claim 17 wherein the chamber is disposed in a rear wall of the drum.

20. The device according to claim 15 wherein the drum includes at least one agitator for moving the textile article when the drum is rotated and wherein the beater is formed as a lever which is movably mounted on the agitator.

21. The device according to claim 20 wherein the lever is optionally fixable to the agitator.

22. The device according to claim 21 wherein the drum comprises at least three agitators.

23. The device according to claim 15 wherein the beater has a length in the range of about 150 mm to about 200 mm.

24. The device according to claim 15 wherein the beater is formed as a cylinder having rounded end portions.

25. The device according to claim 24 wherein the beater has a diameter in the range of about 50 mm to about 70 mm.

26. The device according to claim 15 wherein the beater has a mass in the range of about 100 g to about 200 g.

27. The device according to claim 15 which wherein the at least one beater includes a plurality of beaters.

28. The device according to claim 15 wherein the device is configured as a washer/dryer.
